(19) United States
(12) Patent Application Publication
(10) Pub. No.: US 2021/0323004 A1
(43) Pub. Date: Oct. 21, 2021

(54) APPARATUS FOR MAINTAINING POOL OR SPA FULL LEVEL

(71) Applicant: James Litteral, St. Cloud, FL (US)

(72) Inventor: James Litteral, St. Cloud, FL (US)

(21) Appl. No.: 17/304,981

(22) Filed: Jun. 29, 2021

Related U.S. Application Data
(63) Continuation-in-part of application No. 16/949,390, filed on Oct. 28, 2020.
Application No. 16/949,390 is a continuation-in-part of application No. 16/666,343, filed on Oct. 28, 2019.
(60) Provisional application No. 62/751,687, filed on Oct. 28, 2018.

(51) Int. Cl. B05B 1/10; E04H 4/12

(52) U.S. Cl. CPC B05B 1/10; E04H 4/12

(57) ABSTRACT

A nozzle including an inlet portion having an inlet housing with an inlet channel having a diameter; and an outlet portion having a first end secured to a first end of the inlet portion, the outlet portion including an outlet housing, and an outlet tube carried by the outlet housing and having an inner diameter less than the diameter of the inlet channel.

### RELATED APPLICATIONS

This application is a continuation-in-part application of and claims priority under 35 U.S.C. § 120 of U.S. patent application Ser. No. 16/949,390 (Attorney Docket No. 5446.00002) filed on Oct. 28, 2020 and titled APPARATUS FOR MAINTAINING POOL OR SPA FULL LEVEL, which in turn is a continuation-in-part of and claims priority under 35 U.S.C. § 120 of U.S. patent application Ser. No. 16/666,343 (Attorney Docket No. 5446.00001) filed on Oct. 28, 2019 and titled APPARATUS FOR MAINTAINING POOL OR SPA FULL LEVEL—STAYPOOLLIZER. The content of these applications is incorporated herein by reference.

### FIELD OF THE INVENTION

The present invention relates to systems and methods for maintaining a fluid level in a body of water. More specifically, this invention is related to a system for connecting a water source to a nozzle configuring a float valve to control the nozzle dependent upon the water level in the body of water.

### BACKGROUND OF THE INVENTION

In the ever-growing pool market, there exists a need to automate the process of replenishing water loss. Low water level can cause serious damage to pool water recirculating and sanitizing sub-systems. Manual replenishment of lost water is time consuming and requires constant monitoring for proper fill level. Known automated methods and systems for maintaining water level require modifications to apparatus based on the setting in which they are used. A known automated system utilizes a mechanical float cut-off action closed and opened by a sealing surface connected to a water buoyant component, but this system has a high failure rate resulting in overfilling. Therefore, a need exists for a reliable system deployable in a variety of environments.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a nozzle including an inlet portion and an outlet portion. The inlet portion may include an inlet housing with an inlet channel having a diameter. The outlet portion may have a first end secured to a first end of the inlet portion and include an outlet housing and an outlet tube. The outlet tube may be carried by the outlet housing and have an inner diameter less than the diameter of the inlet channel.

The inner diameter of the outlet tube may be between 0.125 and 0.123 inches.

The outlet housing may have an outlet channel having a diameter larger than the inner diameter of the outlet tube and at least a portion of the outlet tube may be positioned within at least a portion of the outlet channel.

A second end of the outlet housing may include a tapered protrusion having a center aligned with the outlet channel.

The outlet tube may extend through an entirety of a length of the tapered protrusion.

The outlet housing may have a transition channel with a first end proximate the inlet channel and a second, opposing end proximate a first end of the outlet tube.

The first end of the transition channel may have a diameter equal to a diameter of the inlet channel and the second end of the transition channel may have a diameter smaller than the diameter of the first end of the transition channel.

The diameter of the second end of the transition channel may be equal to a diameter of the outlet channel.

A sidewall of the transition channel may form an angle between 35 and 40 degrees with respect to a longitudinal axis of the transition channel.

The outlet portion may further include a threaded connector disposed on an exterior surface thereof.

The inlet portion may further include a threaded connector disposed on an interior surface of the inlet housing.

The inlet portion may further include a quick connect connector receptacle.

The inlet portion may rotatably secure to the outlet portion.

The valve may further include a joint secured between the inlet portion and the outlet portion. The joint may be operable to position a second end of the inlet portion at a ninety-degree angle with respect to a second end of the outlet portion.

### BRIEF DESCRIPTION OF THE DRAWINGS

Some embodiments of the present invention are illustrated as an example and are not limited by the figures of the accompanying drawings, in which like references may indicate similar elements.

FIG. 1 is an environmental view of a system for maintaining a water level according to an embodiment of the present invention.

FIG. 2 is a perspective view of a securing member of the system for maintaining a water level of FIG. 1.

FIG. 3 is a perspective view of a float valve of the system for maintaining a water level of FIG. 1.

FIG. 4 is a top plan view of the float valve of FIG. 3.

FIG. 5 is a top perspective view of a nozzle of the system for maintaining a water level of FIG. 1.

FIG. 6 is a side elevation view of the nozzle of FIG. 5.

FIG. 7 is a top plan view of the nozzle of FIG. 5

FIG. 8 is a bottom plan view of the nozzle of FIG. 5.

FIG. 9 is a bottom perspective view of the nozzle of FIG. 5.

FIG. 10 is a side elevation view of the outlet tube of the nozzle of FIG. 5.

FIG. 11 is a side elevation view of a nozzle of the system for maintaining a water level according to an embodiment of the present invention.

FIG. 12 is a side elevation view of a nozzle of the system for maintaining a water level according to an embodiment of the present invention.

FIG. 13 is a front perspective view of a nozzle according to an embodiment of the present invention.

FIG. 14 is a rear perspective view of the nozzle of FIG. 13.

FIG. 15 is a side elevation view of the nozzle of FIG. 13.

FIG. 16 is a cross section view of the nozzle through line 16-16 of FIG. 15.

FIG. 17 is a top plan view of the nozzle of FIG. 13.

FIG. 18 is a bottom plan view of the nozzle of FIG. 13.

FIG. 19 is an exploded view of the nozzle of FIG. 13.

FIG. 20 is a front perspective view of a nozzle according to an embodiment of the present invention.

FIG. 21 is a rear perspective view of the nozzle of FIG. 20.

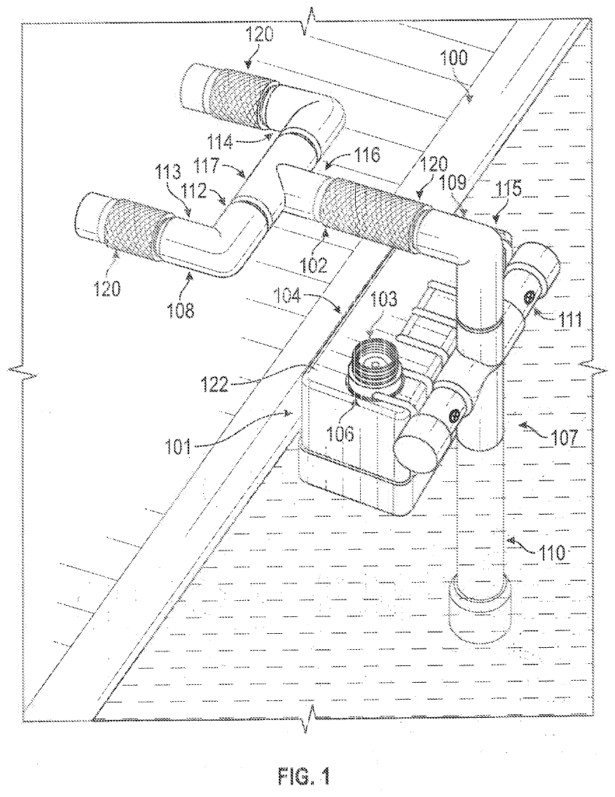

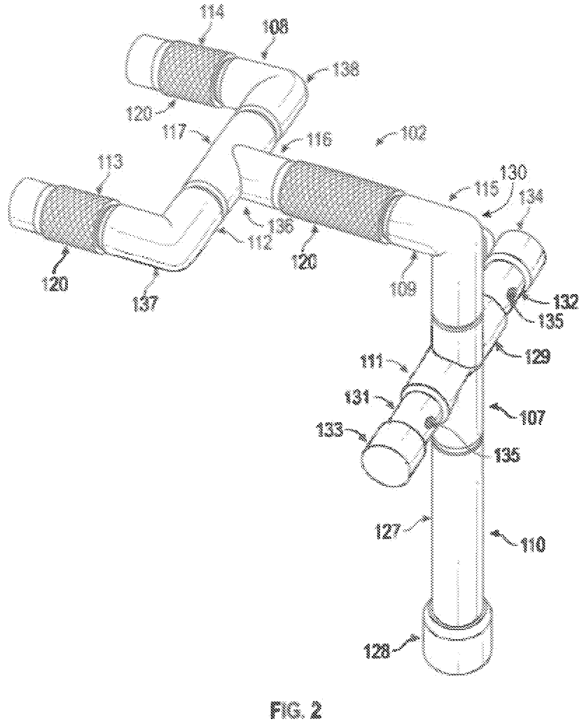

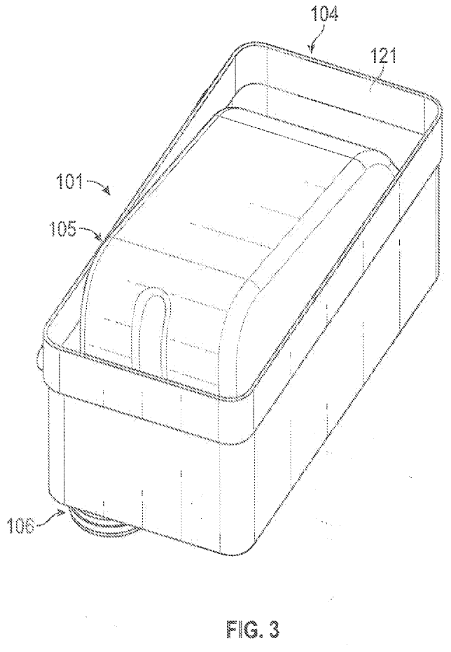

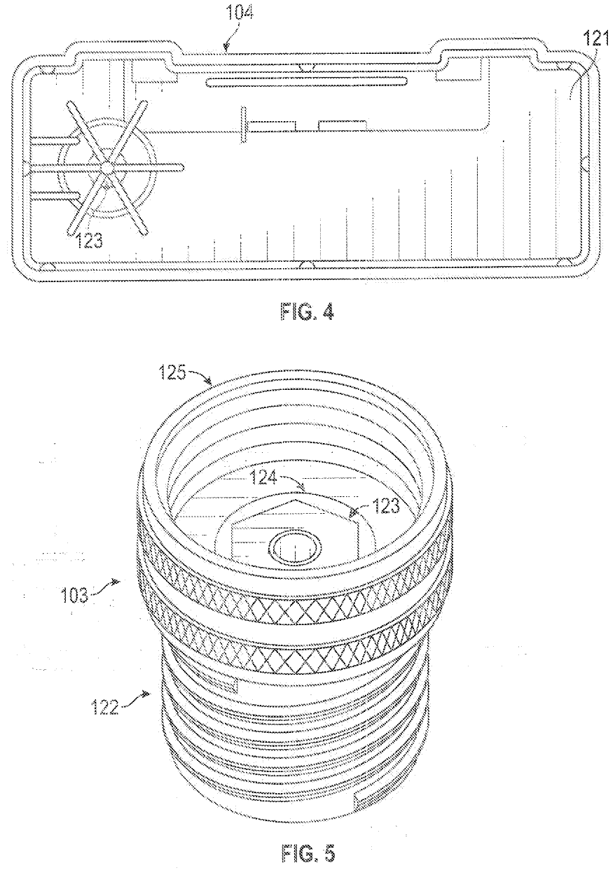

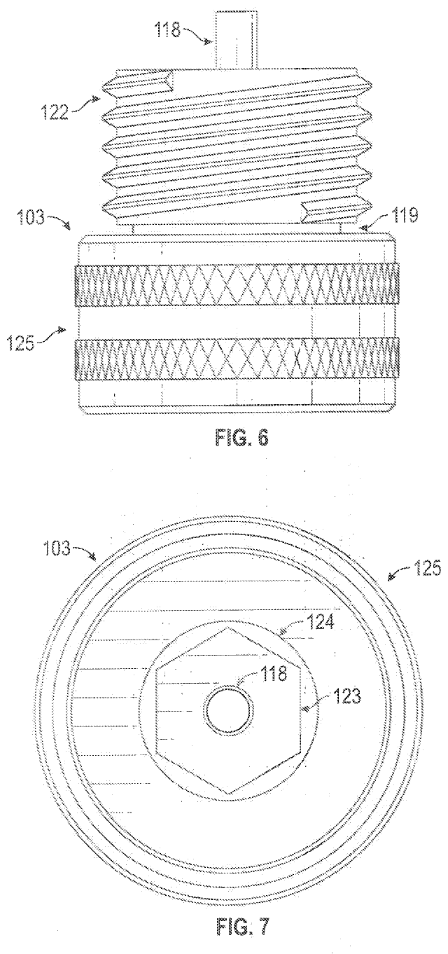

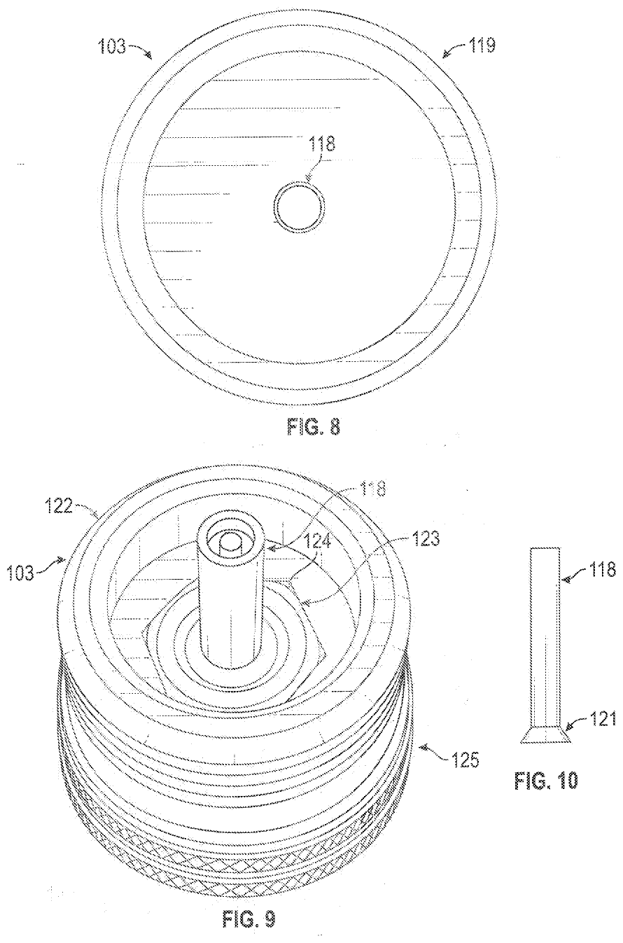

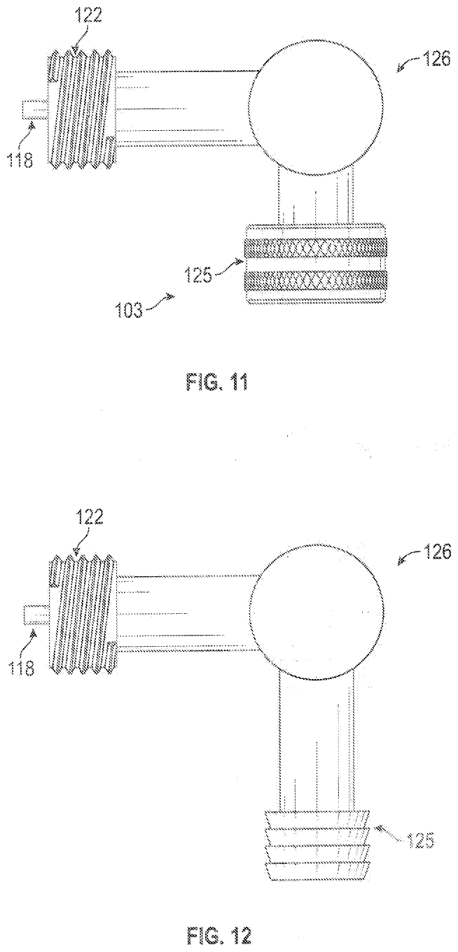

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a system for maintaining a water level 100. The system may include a float valve 101, a securing member 102, and a nozzle 103. The securing member 102 may carry the nozzle 103 and float valve 101 and anchor the system 100 at a particular location to position the float valve 101 along a surface of the body of water. The nozzle 103 may be connected to a water source providing water to the body of water. As the water surface rises to a desired level, the float valve 101 may be operable to occlude the nozzle 103 to prevent further water from entering the body of water. As the water level falls, the float valve 101 may be operable to move away from an outlet tube 118 of the nozzle 103 and allow water to flow into the body of water to raise the water level.

The securing member 102 may include a support member 107, an adjustable member 108, and a horizontal member 109. The components of the securing member 102 may include hollow tubes, caps, and connectors. In one embodiment, the securing member 102 may include PVC components, which are particularly well suited to the environment in which the system for maintaining a water level 100 may be utilized.

The support member 107 may secure directly to the float valve 101. The support member 107 may include a cross-member 111 and a vertical member 110. The vertical member 110 may secure to the cross-member 111 perpendicularly to one another. When the system is in operation, the cross-member 111 may be positioned parallel to the surface of the body of water and the vertical member 110 may be positioned along a plane ninety degrees from the plane of the surface of the water. In one embodiment, the vertical member 110 may include a vertical hollow tube 127 having a vertical tube cap 128 on a first end. A second end of the vertical hollow tube may be secured to an equal cross fitting 129. The vertical hollow tube 127 may terminate within the equal cross fitting 129 or extend through the equal cross fitting 129 and protrude from a pair of opposing outlet portions of the equal cross fitting 129. In embodiments in which the vertical hollow tube 127 terminates within the equal cross fitting, a second vertical hollow tube may be capture by and extend from an outlet portion of the equal cross fitting 129 opposing the outlet portion secured to the first vertical hollow tube 127.

The equal cross fitting 129 may be hollow and have four outlet portions. Each of the four outlet portions may directly oppose another outlet portion and form a ninety-degree angle with two other outlet portions. The first or second hollow tube portion 127 extending from the outlet portion of the equal cross fitting 129 directly opposing the outlet portion secured to the second end of the first vertical member 127 may secure to a first end of a ninety-degree elbow 130. The vertical member 110 may include all or parts of the ninety-degree elbow 130, equal cross fitting 129, first vertical hollow tube 127, second vertical hollow tube, and vertical tube cap 128.

The cross member 111 may include the two outlet portions of the equal cross fitting 129 not secured to portions of the vertical member 110. Each of these outlet portions of the cross member 111 maybe secured to a first end of a hollow tube 131, 132. The second ends of each of these hollow tubes 131, 132 may be secured to respective cross member caps 133, 134. Alternatively, the cross member 111 may include a single hollow tube 131 extending through the equal cross fitting 129 from a first side to a second, opposing side. In such an embodiment, each end of the single hollow tube 131 may be secured to a respective cross member cap 133, 134. The cross member 111 may include one or more fasteners 135 adapted to secure directly to the housing 104 of the float valve 101. In one embodiment, the one or more fasteners 135 may be a pair of screws.

The horizontal member 109 may have a first end 115 secured to the ninety-degree elbow 130 of the support member 107 and a second, opposing end 116 secured to a tee member 136. The tee member 136 may include a hollow tube 117 to rotatably capture and secure to the adjustable member 108. The adjustable member may be rotatably positionable with respect to the horizontal member 109.

The adjustable member 108 may include a mounting member 112, which may be a single tube, carried by the hollow tube 117 and extending from opposing ends of the hollow tube 117 of the tee member 136. Each end of the mounting member 112 may be secured to a first end of a respective elbow 137, 138. In one embodiment, each elbow 137, 138 may form a ninety-degree angle. The second end of each elbow 137, 138 may secure to a first end of an extension member 113, 114. The extension members 113, 114 may be parallel to one another and perpendicular to the mounting member 112. The second end of each extension member 113, 114 may secure to a respective extension cap 139, 140. The adjustable member 108 may be rotated within the hollow tube 117 to position the extension members 113 at any angle between zero and three hundred sixty degrees with respect to the horizontal member 109. Adjusting the angle of the adjustable member 108 may allow the system to be placed and retained on the side of a body of water regardless of the structure of the surface surrounding the body of water. By way of example, when the body of water is a swimming pool, there may be a coping surrounding the pool that angles up, down, or remains flat. The adjustable member 108 may be positioned to maximize contact with the surface upon which it rests regardless of the angle of the coping. The interior of all hollow pipes, excluding the support member 107 and hollow tubes 131 and 132 may be filled with dead weight to increase frame stability. The introduction of deadweight may be beneficial due to wave action created during pool use or water currents within the body of water due to circulation.

To further retain the system 100 in the desired position, a portion of the system 100 may include a slip resistant surface 120. In one embodiment, a slip resistant surface 120 may be located along an entirety of portion of an outer perimeter surface of each extension member 113, 114. A slip resistant surface 120 may be located along an entirety of a portion of an outer perimeter surface of the horizontal member 109.

The float valve 101 may include a housing 104, a float 105, and a connector 106. The housing 104 may have a hollow interior 121 and a top surface 122 with an orifice 123 disposed through an entirety of the thickness of the top surface 122. The orifice 123 may be in fluid communication with the nozzle 103 of the system 100. The connector 106 may be secured to the top surface 122 of the housing 104, be adapted to carry the nozzle 103, and position the nozzle in fluid communication with the orifice 123.

The float 105 may pivotally secure to the housing 104 within the hollow interior 121 of the housing 104 below the top surface 122. The float 105 may be a hollow, generally rectangular, buoyant structure. The top surface of the float 105 may rise and fall as the water level of the body of water rises and falls. As the water level rises, a neoprene washer of the float 105 may contact and occlude the orifice 123 of the housing 104 and prevent water from passing through the nozzle 103 into the body of water. As the water level falls, the float 105 may move away from the orifice 123 of the housing 104 and allow water to pass through the nozzle 103 and enter the body of water. At a desired water level, the float 105 may prevent additional water from entering the body of water through the nozzle 103. When the water level drops below a desired water level, the float 105 may allow additional water to enter the body of water through the nozzle 103.

The nozzle 103 may include an inlet tube 119 adapted to receive water entering the nozzle 103. The inlet tube 119 may have an inner diameter. The nozzle 103 may also include an outlet tube 118 adapted to expel water from the nozzle 103 into the orifice 123 of the housing 104. The outlet tube 118 may have an inner diameter less than the inner diameter of the inlet tube 119. In one embodiment, the inner diameter of the outlet tube may be between 0.125 and 0.123 inches. In one embodiment, the inner diameter of the outlet tube may be 0.124 inches. The outlet tube 118 may have an outer diameter between 0.16 and 0.15 inches. In one embodiment, the outer diameter of the outlet tube 118 may be 0.155 inches. A first end 121 of the outlet tube 118 may be positioned proximate the inlet to the nozzle 103 with a second end of the outlet tube 118 positioned proximate the orifice 123 of the housing 104. As depicted in FIG. 10, the first end 121 of the outlet tube 118 may be flared. In one embodiment, the flare of the outlet tube 118 may form a forty-five degree angle with a longitudinal axis of the outlet tube 118.

The nozzle 103 may include a threaded connector 122. The threaded connector 122 may be adapted to mate with threads on the connector 106 of the float valve 101. In one embodiment, the threaded connector 122 of the nozzle 103 may have threads located on an outer perimeter, which mate with threads on an inner perimeter of the connector 106 of the float valve 101. The threaded connector 122 of the nozzle 103 may surround and carry at least a portion of the outlet tube 118. The threaded connector 122 of the nozzle 103 may secure to the inlet tube 119 of the nozzle 103.

The nozzle 103 may include a flange nut 123, which may be positioned between the outlet tube 118 and the threaded connector 122. The first end 121 of the outlet tube 118 may be positioned within a center void of the flange nut 123. The flange nut 123 may secure to an outer diameter of the outlet tube 118. The flange nut 123 may be captured by and carried within the threaded connector 122. The flange nut 123 may be positioned within an inner perimeter of the threaded connector 122. Space between an outer perimeter of the flange nut 123 and the inner perimeter of the threaded connector 122 may be filled with epoxy resin 124. Additionally, epoxy resin 124 may fill an entirety of a void between the outer diameter of the outlet tube 118 and the inner diameter of the threaded connector 122.

The nozzle may include a hose connector 125. The hose connecter 125 may be adapted to secure to a hose, which provides water to increase the level of the body of water. In one embodiment, the hose connector 125 may include threads located on an inner diameter of the inlet tube 119. In another embodiment, the hose connector 125 may include a quick connect style connector secured to or positioned on an exterior perimeter of the inlet tube 119. The hose connector 125 may be coupled to the threaded connector 122 of the nozzle 103. When secured to one another, the hose connector 125 and the threaded connector 122 may swivel with respect to one another. In one embodiment, a joint 126 may be positioned between the hose connector 125 and the threaded connector 122. In such an embodiment, the joint 126 may be operable to position the fluid inlet of the hose connector 125 at angle of other than one hundred eighty degrees with respect to the fluid outlet of the outlet tube 118. In one embodiment, the joint 126 may be operable to achieve an angle between one hundred eighty and ninety degrees.

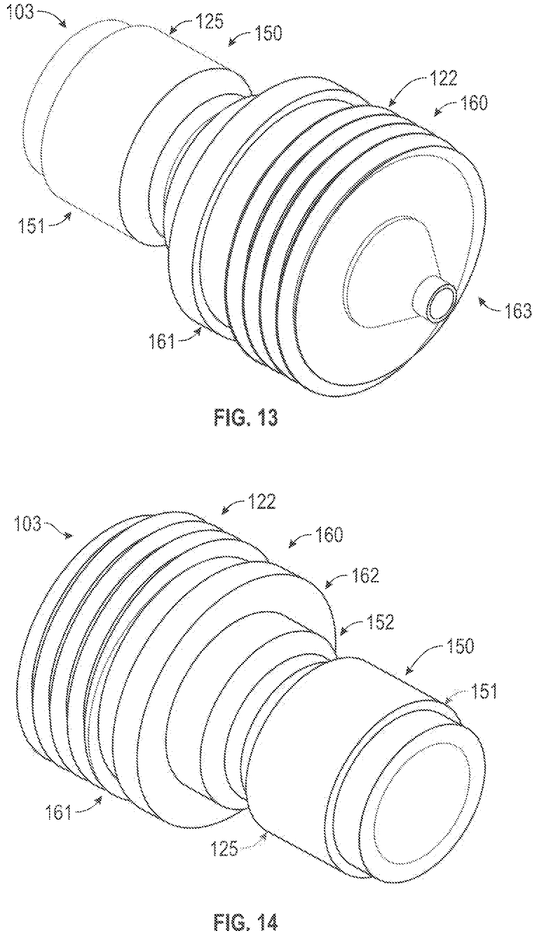

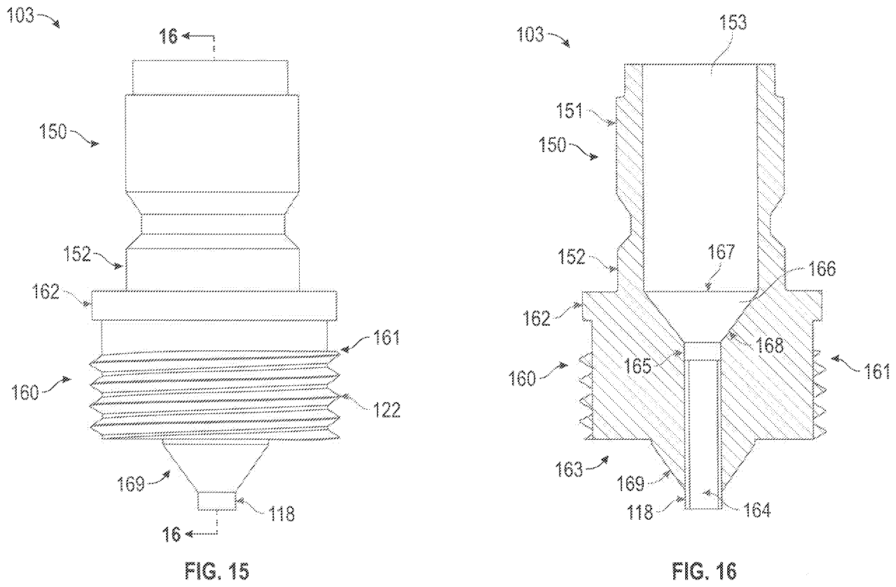

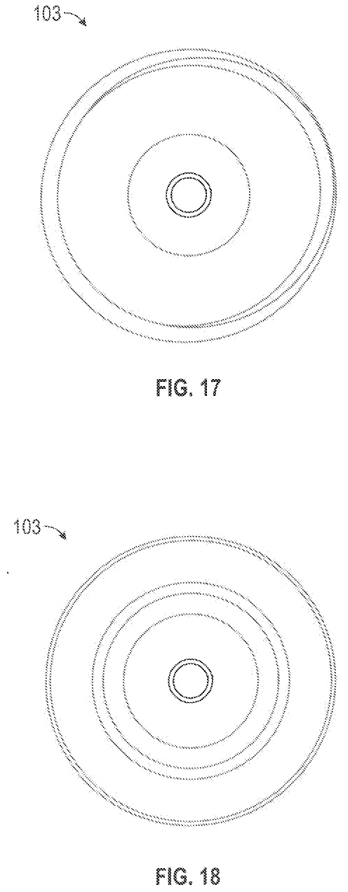

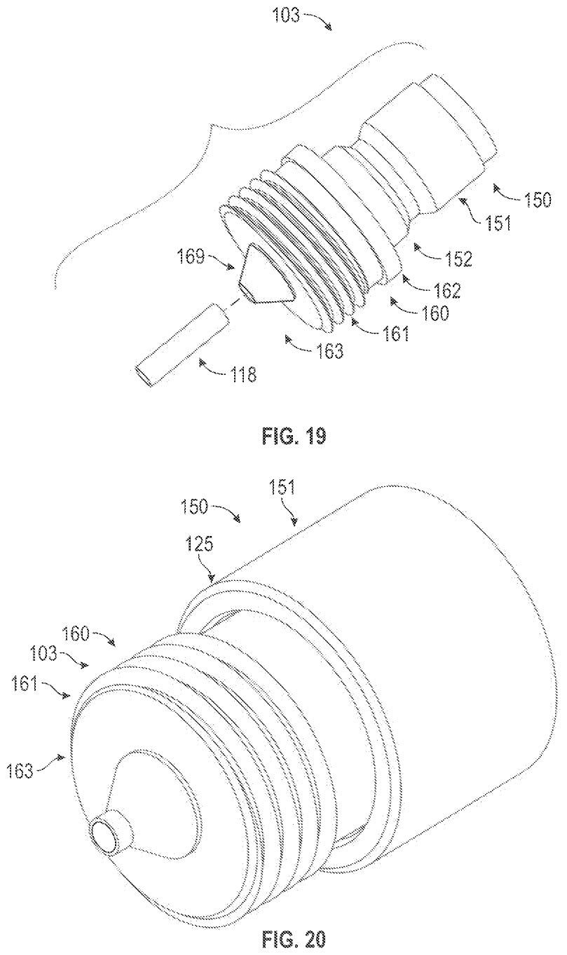

In one embodiment, as depicted at least in FIGS. 13-21, a nozzle 103 including both an inlet portion 150 and an outlet portion 160 is shown. The nozzle 103 may be used with the float valve 101 and securing member 102. As depicted, the inlet portion 150 of the nozzle 103 may include an inlet housing 151 with an inlet channel 153. The inlet channel 153 may extend along an entirety of the length of the inlet housing 151 and be centered on the longitudinal axis thereof. The inlet channel 153 may be circular and have a diameter with an opening of the inlet channel 153 at both the first end 152 and second end of the inlet portion 150. The first end 152 of the inlet portion 150 may secure to the first end 162 of the outlet portion 160. In one embodiment, the inlet portion 150 may rotatably secure to the outlet portion 160 with a swivel-type connection. In one embodiment, a joint 126 may be secured between the first end 152 of the inlet portion 150 and the first end 162 of the outlet portion 160. The joint 126 may be operable to selectively position the second end of the inlet portion 150 either in line with or at a ninety degree angle to the second end 163 of the outlet portion 160.

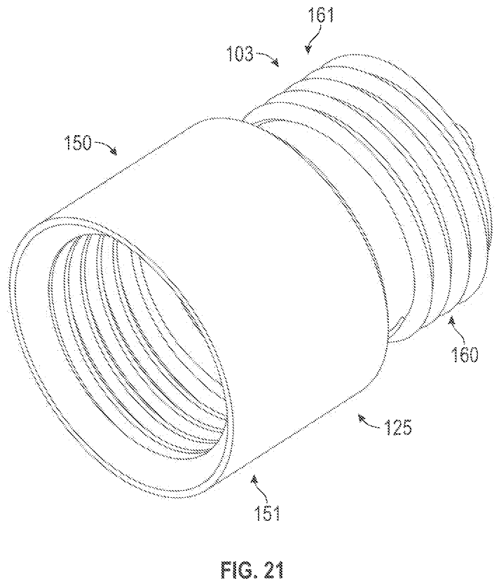

The inlet portion 150 may include a hose connector 125 adapted to secure a hose or other water source to the second end of the inlet portion 150. In one embodiment, as shown at least in FIGS. 20 and 21, the hose connector 125 may include a threaded connector located on an interior surface of the inlet housing 151. In another embodiment, as shown at least in FIGS. 13-19, the hose connector 125 may include a quick connect connector receptacle.

The outlet portion 160 may include an outlet housing 161 and an outlet tube 118. The outlet portion 160 may have a first end 162 and an opposing second end 162. The outlet portion 160 may have a securing mechanism adapted to secure the second end 163 of the outlet portion 160 to an inlet of the float valve. In one embodiment, the securing mechanism may include a threaded connector 122 located on an exterior surface of the outlet portion 160 proximate the second end 163.

The outlet tube 118 may be carried by the outlet housing 161 and have an opening at the second end 162 of the outlet portion 160. The outlet tube 118 may be a hollow cylindrical tube carried by the outlet housing 161. The inner diameter of the outlet tube 118 may be smaller than the diameter of the inlet channel 153. In one embodiment, the inner diameter of the outlet tube may be between 0.125 and 0.123 inches, preferably 0.124 inches in diameter.

The outlet housing 162 may have an outlet channel 164 adapted to carry at least a portion of the outlet tube 118. The outlet channel 164 may be formed through an entirety of the length of the outlet housing 162 and may be centered along a longitudinal axis of the outlet housing 162. The diameter of the outlet channel 164 may be larger than the inner diameter of the outlet tube 118. At least a portion of the outlet tube 118 may be positioned within the outlet channel 164 and secured therein with an interference fit or with an adhesive. The first end 165 of the outlet channel 164 may oppose the second end of the outlet channel 164 and may be positioned proximate the inlet portion 150, or transition channel 166, and distal the second end of the outlet portion 163.

The outlet housing 162 may have a first end proximate the first end of the inlet portion 150. The second end of the outlet housing 162 may oppose the first end of the outlet portion 160 and be positioned at the second end 163 of the outlet portion 160. A tapered protrusion 169 may be secured to the second end 163 of the outlet portion 160. The tapered protrusion 169 may have a channel formed along an entirety of its length. The channel may be cylindrical and adapted to allow a fluid to pass from the interior cavity of the outlet portion 160 to the exterior of the outlet portion 160, exiting at a second end 163 of the outlet portion. The channel of the tapered protrusion 169 may be centered on the tapered protrusion 169 and aligned with the outlet channel 164.

The outlet tube 118 may be carried by the tapered protrusion 169. In one embodiment, the outlet tube 118 may extend through an entirety of the length of the tapered protrusion 169.

The outlet housing 161 may also include a transition channel 166. A first end 167 of the transition channel 166 may be positioned proximate the inlet channel 153 of the inlet housing 151. Fluid may flow into the nozzle 103 at the second end of the inlet portion 150, enter the inlet channel 153, flow into the transition channel 166, and exit the nozzle 103 through the outlet tube 118. The second end 168 of the transition channel 166 may oppose the first end 167 and be proximate the first end 121 of the outlet tube 121.

The diameter of the transition channel 166 may taper between the first end 167 and second end 168, The first end 167 of the transition channel 166 may be adjacent the inlet channel 153 and have a diameter equal to the diameter of the inlet channel 153. The second end of the transition channel 166 may be smaller than the first end 167. In one embodiment, the second end 168 of the transition channel 166 may be adjacent a first end 121 of the outlet tube 118 and have a diameter equal to the interior diameter of the outlet tube 188 or the outlet channel 164. In one embodiment, the sidewalls of the transition channel 166 may taper at an angle between 35 and 40 degrees with respect to a longitudinal axis of the transitional channel 166.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

The claims in the instant application are different than those of the parent application or other related applications. Applicant therefore rescinds any disclaimer of claim scope made in the parent application or any predecessor application in relation to the instant application. Any such previous disclaimer and the cited references that it was made to avoid, may need to be revisited. Further, any disclaimer made in the instant application should not be read into or against the parent application.

What is claimed is:

1. A nozzle comprising:
an inlet portion comprising:
an inlet housing with an inlet channel having a diameter; and
an outlet portion having a first end secured to a first end of the inlet portion and comprising:
an outlet housing, and
an outlet tube carried by the outlet housing and having an inner diameter less than the diameter of the inlet channel.

2. The system of claim 1 wherein the inner diameter of the outlet tube is between 0.125 and 0.123 inches.

3. The system of claim 1 wherein the outlet housing has an outlet channel having a diameter larger than the inner diameter of the outlet tube and at least a portion of the outlet tube is positioned within at least a portion of the outlet channel.

4. The system of claim 3 wherein a second end of the outlet housing comprises a tapered protrusion having a center aligned with the outlet channel.

5. The system of claim 4 wherein the outlet tube extends through an entirety of a length of the tapered protrusion.

6. The system of claim 1 wherein the outlet housing has a transition channel with a first end proximate the inlet channel and a second, opposing end proximate a first end of the outlet tube.

7. The system of claim 6 wherein the first end of the transition channel has a diameter equal to a diameter of the inlet channel and the second end of the transition channel has a diameter smaller than the diameter of the first end of the transition channel.

8. The system of claim 7 wherein the diameter of the second end of the transition channel is equal to a diameter of the outlet channel.

9. The system of claim 8 wherein a sidewall of the transition channel forms an angle between 35 and 40 degrees with respect to a longitudinal axis of the transition channel.

10. The system of claim 1 wherein the outlet portion further comprises:
a threaded connector disposed on an exterior surface thereof.

11. The system of claim 1 wherein the inlet portion further comprises a threaded connector disposed on an interior surface of the inlet housing.

12. The system of claim 1 wherein the inlet portion further comprises a quick connect connector receptacle.

13. The system of claim 1 wherein the inlet portion is rotatably secured to the outlet portion.

14. The system of claim 1 further comprising a joint secured between the inlet portion and the outlet portion wherein the joint is operable to position a second end of the inlet portion at a ninety-degree angle with respect to a second end of the outlet portion.

15. A nozzle comprising:
an inlet portion comprising:
an inlet housing with an inlet channel having a diameter; and
an outlet portion having a first end secured to a first end of the inlet portion and comprising:
an outlet housing having a transition channel with a first end of the transition channel proximate the inlet channel and a second, opposing end of the transition channel proximate a first end of an outlet tube, and
the outlet tube carried by the outlet housing and having an inner diameter less than the diameter of the inlet channel;
wherein the first end of the transition channel has a diameter equal to a diameter of the inlet channel and the second end of the transition channel has a diameter smaller than the diameter of the first end of the transition channel;
wherein the diameter of the second end of the transition channel is equal to a diameter of the outlet channel; and
wherein a sidewall of the transition channel forms an angle between 35 and 40 degrees with respect to a longitudinal axis of the transition channel.

16. The system of claim 15 wherein the outlet housing has an outlet channel having a diameter larger than the inner diameter of the outlet tube and at least a portion of the outlet tube is positioned within at least a portion of the outlet channel.

17. The system of claim 16 wherein a second end of the outlet housing comprises a tapered protrusion having a center aligned with the outlet channel.

18. The system of claim 17 wherein the outlet tube extends through an entirety of a length of the tapered protrusion.

19. The system of claim 15 wherein the inlet portion is rotatably secured to the outlet portion.

20. A nozzle comprising:
an inlet portion comprising:
an inlet housing with an inlet channel having a diameter; and
an outlet portion having a first end rotatably secured to a first end of the inlet portion and comprising:
an outlet tube carried by an outlet housing and having an inner diameter less than the diameter of the inlet channel, and
the outlet housing comprising:
an outlet channel with a diameter of the outlet channel larger than the inner diameter of the outlet tube and at least a portion of the outlet tube positioned within at least a portion of the outlet channel, and
a transition channel with a first end proximate the inlet channel and a second, opposing end proximate a first end of the outlet tube, and
a threaded connector disposed on an exterior surface of the outlet housing;
wherein the first end of the transition channel has a diameter equal to a diameter of the inlet channel and the second end of the transition channel has a diameter smaller than the diameter of the first end of the transition channel;
wherein the diameter of the second end of the transition channel is equal to a diameter of the outlet channel;
wherein a sidewall of the transition channel forms an angle between 35 and 40 degrees with respect to a longitudinal axis of the transition channel;
wherein a second end of the outlet housing comprises a tapered protrusion having a center aligned with the outlet channel;
wherein the outlet tube extends through an entirety of a length of the tapered protrusion.
